(19) United States
(12) Patent Application Publication
(10) Pub. No.: US 2006/0266485 A1
(43) Pub. Date: Nov. 30, 2006

(54) Paper or paperboard having nanofiber layer and process for manufacturing same

(76) Inventors: David E. Knox, Goose Creek, SC (US); Edward P. Klein, Goose Creek, SC (US); Vladislav A. Babinsky, Grove City, OH (US); Ashley S. Scott, Grove City, OH (US)

Correspondence Address: THOMPSON HINE L.L.P., P.O. BOX 8801, DAYTON, OH, 45401-8801, US

(21) Appl. No.: 11/136,292

(22) Filed: May 24, 2005

(51) Int. Cl. D21F 11/00; B05D 1/12

(52) U.S. Cl. 162/135; 162/157.1; 427/180

(57) ABSTRACT

A method for forming a web or paper or paperboard includes forming a web of cellulose paper fibers and producing a nanoweb of nanofibers on the web of cellulose paper fibers.

### BACKGROUND OF THE INVENTION

The present invention relates to a method for manufacturing a web of paper or paperboard. More particularly, the invention relates to a paper or paperboard manufacturing method comprising the steps of forming a web of cellulose paper fibers, producing a plurality of nanofibers and applying the nanofibers to the web to produce a composite paper web comprising a nanoweb layer and a cellulose-fiber layer.

Paper is manufactured by an essentially continuous production process wherein a dilute aqueous slurry of cellulosic fiber flows into the wet end of a paper machine and a consolidated dried web of indefinite length emerges continuously from the paper machine dry end. The wet end of the paper machine comprises one or more headboxes, a drainage section and a press section. The dry end of a modern paper machine comprises a multiplicity of steam heated, rotating shell cylinders distributed along a serpentine web traveling route under a heat confining hood structure. Although there are numerous design variations for each of these paper machine sections, the commercially most important of the variants is the fourdrinier machine wherein the headbox discharges a wide jet of the slurry onto a moving screen of extremely fine mesh.

The screen is constructed and driven as an endless belt carried over a plurality of support rolls or foils. A pressure differential across the screen from the side in contact with the slurry to the opposite side draws water from the slurry through the screen while that section of the screen travels along a table portion of the screen route circuit. As slurry dilution water is extracted, the fibrous constituency of the slurry accumulates on the screen surface as a wet but substantially consolidated mat. Upon arrival at the end of the screen circuit table length, the mat has accumulated sufficient mass and tensile strength to carry a short physical gap between the screen and the first press roll. This first press roll carries the mat into a first press nip wherein the major volume of water remaining in the mat is removed by roll nip squeezing. One or more additional press nips may follow.

From the press section, the mat continuum, now generally characterized as a web, enters the dryer section of the paper machine to have the remaining water removed thermodynamically.

In recent years, fourdrinier machines have been developed to make paperboard having multiple, independent layers or plies of papermaking stock laid together or in closely spaced sequence along a single forming section of the fourdrinier screen circuit. What is referred to herein as layers or plies is to be distinguished from a laminated composite of independently formed solid sheet having a sharply defined interface between juxtaposed sheet surfaces. In the case of multi-ply fourdrinier-formed paper or paperboard, such as the present invention, each of the “layers” or “plies” could more accurately be described as a “zone” that transitions substantially seamlessly into the adjacent zone. The interface is not a plane but a transition zone of proportionately significant thickness wherein the fiber of adjacent zones are commingled.

Generally speaking, the most important fibers for the manufacture of paper are obtained from softwood and hardwood tree species. However, fibers obtained from straw or bagasse have been utilized in certain cases. Both chemical and mechanical defiberizing processes, well known to the prior art, are used to separate papermaking fiber from the composition of natural growth. Papermaking fiber obtained by chemical defiberizing processes and methods is generally called chemical pulp whereas papermaking fiber derived from mechanical defiberizing methods may be called groundwood pulp or mechanical pulp. There also are combined defiberizing processes such as semichemical, thermochemical or thermomechanical. Either of the tree species may be defiberized by either chemical or mechanical methods. However, some species and defiberizing processes are better economic or functional matches than others.

An important difference between chemical and mechanical pulp is that mechanical pulp may be passed directly from the defiberizing stage to the paper machine. Chemical pulp on the other hand must be mechanically defiberized, washed and screened, at a minimum, after chemical digestion. Usually, chemical pulp is also mechanically refined after screening and prior to the paper machine. Additionally, the average fiber length of mechanical pulp is, as a rule, shorter than that of chemical pulp. However, fiber length is also highly dependent upon the wood species from which the fiber originates. Softwood fiber is generally about three times longer than hardwood fiber.

The ultimate properties of a particular paper are determined in large part by the species of raw material used and the manner in which the paper machine and web forming process treat these raw materials. Important operative factors in the mechanism of forming the paper web are the headbox and screen.

The particular fiber material or stock from which the paper is manufactured is, by nature, generally highly nonhomogeneous with respect to both the length and the thickness of the fibers. The longest fibers are of an order of about 2 to 3 mm, while the shortest fibers are about 1/10 of this length. Only a few paper grades are produced by using a single fiber type alone. In most cases, at least two kinds of fiber are used for paper.

Applying a paper coating is a very common way to enhance the surface properties of paper. However, paper-coating equipment can be very complex and expensive. Typically, coating weights from about 2-6 lbs./1000 ft² are required to substantially enhance surface properties of the paper. Such a relatively high coat weight can result in substantial expenses with respect to coating materials and result in an increase in the basis weight of the finished paper. A high coat weight is usually required because lower coating weights are typically not uniform enough to provide the desired improvement in surface properties. Non-uniformity associated with low coating weights can be particularly problematic when coating unbleached board. Because of the brown fibers in the unbleached board, it is particularly important that the coating, which is typically white, cover the brown board completely. Preferably, the final coated surface should be uniform to provide acceptable appearance and printing properties. Therefore, it would be desirable to provide a paper or paperboard product having the desired properties while eliminating or reducing the amount of paper coating required.

### SUMMARY OF THE INVENTION

The present invention relates to paper or paperboard containing a secondary web of nanofibers on a base web of cellulose fibers. The invention also relates to methods for manufacturing the described paper or paperboard products. In accordance with one aspect of the invention, a plurality of nanofibers are applied to a web of cellulose paper fibers to produce a composite paper web comprising a nanoweb and the base cellulose fiber web. In accordance with a particular embodiment of the invention, the nanofibers are applied to the web of paper fibers at a dryness level of the paper fiber web of about 40% to about 100% by weight. In accordance with another embodiment of the invention, a binder is provided between the nanoweb and the cellulose web to improve bonding therebetween.

In accordance with particular aspects of the invention, the nanofibers are produced using an electrospinning device. Electrospinning technology (EST) is a technique that can be used to apply a uniform web of nanofibers over the surface of a substrate. Electrospinning makes it possible to incorporate a variety of fibers such as polymeric, metaloxide, or metaloxide/polymeric composite nanofibers directly onto the surface of a paper. In accordance with certain aspects of the present invention, the nanofibers are applied to the forming paper web in a certain zone where the dryness of the paper web will favorable for the application of nanofibers on the surface of the cellulose paper web.

### DETAILED DESCRIPTION OF THE INVENTION

In describing the preferred embodiment, certain terminology will be utilized for the sake of clarity. It is intended that such terminology include not only the recited embodiments but all technical equivalents that operate in a similar manner, for a similar purpose, to achieve a similar result. The citation of any document is not to be construed as an admission that it is prior art with respect to the present invention.

The present invention is directed to a method of forming a paper or paperboard containing a nanoweb. The term “nanoweb” as used herein refers to one or more layers comprising nanofibers. The paper or paperboard may be formed by applying nanofibers to a web of cellulose paper fibers to produce a composite paper web comprising a nanoweb layer and a cellulose-fiber layer. In accordance with a particular embodiment of the invention, the nanofibers are produced using an electrospinning device on a paper machine. More particularly, the electrospinning device may be located in a certain zone of the paper machine where the dryness of the paper web will be favorable for application of nanofibers generated by electrospinning.

The nanoweb and cellulose fiber web should be adequately bonded to prevent separation during use. Sufficient bonding can typically be achieved by selection of an appropriate material for the nanofibers having a certain melting temperature and certain thermo-mechanical and hardening characteristics. However, selection of nanofiber materials meeting these conditions can essentially limit the materials that can be used with electrospinning technology. In accordance with the present invention, an increased number of materials can be used to form the nanofibers by installing the electrospinning device on the paper machine in the area of dryness from about 40% to 100% by weight, more particularly from about 50 to about 80% and in accordance with certain embodiments from about 55 to about 75%. Under these conditions, the contraction of fiber structure of the cellulose paper web during drying will help to secure the nanofibers in the fiber structure of the cellulose paper forming inner bonding between the paper web and the nanoweb. For example, the electrospinning device may be positioned at various points of the forming paper web. It may be positioned between or in place of one of the sets of press rolls or it may be located between the last press rolls and the dryer section. In accordance with one aspect of the invention, the cellulose paper web may be calendered to a Parker Print smoothness of between about 2 and 6 microns prior to application of the nanoweb. Parker Print smoothness is determined in accordance with TAPPI standard T 555 om-99.

In accordance with a particular embodiment of the present invention, the electrospinning device is located in the drying section of the paper machine. Typically, in accordance with certain aspects of the invention, the nanofibers are already dry when they contact the paper web. Therefore, no additional energy is required to dry the nanofiber web after application. In accordance with a more particular aspect of this embodiment, there may be from about 5 to 15 drying cylinders installed before the electrospinning device and from about 10 to 100 drying cylinders after the electrospinning device. Furthermore, the electrospinning device may be positioned relative to the paper machine so as to apply the nanofibers to either surface of the forming paper web. More than one electrospinning device may be employed to apply nanofibers to both sides of the forming paper web.

In accordance with other embodiments of the present invention, bonding between the nanoweb and cellulose paper web can be improved by providing a binder between the two webs. Binders, useful in adhering the nanoweb to the paper web, are not particularly limited so long as they are compatible with the materials used in forming the nanoweb. Particularly, the useful binders include polyvinyl alcohol and polyvinyl pyrrolidone. The binder may be applied to the forming paper web by any conventional technique known to those skilled in the art. In accordance with the particular embodiments of the present invention, the binder composition is sprayed onto the surface of the cellulose fiber web. In accordance with particular aspects of the present invention, the binder is applied to the cellulose web before application of the nanoweb.

The binder compositions, having the appropriate concentration and viscosity, can be determined by one of ordinary skill in the art. The glass transition temperature for particularly useful binders is typically between about 10 and 100° C., more particularly between about 20 and 50° C. The binder compositions may comprise one or more adjunct materials or optional ingredients to improve the application process or binding of the nanoweb and the paper web. The amount of binder applied is not particularly limited but will usually be between about 0.05 and about 15 gsm (0.01 lb/1000 ft² and about 3 lb/1000 ft²) based on dry weight, more particularly from about 0.05 to about 2 gsm (0.01 lb/1000 ft²to about 0.4 lb/1000 ft²).

Electrospinning (electrostatic spinning) is a process based on the use of high voltages (e.g., 10-100 kV) to generate ultra fine fibers with diameters in the range of about 10 nm to 500 microns. This technology utilizes an electric field to generate sufficient surface charge to overcome the surface tension in a viscous drop of polymer melt, solution, and/or gel. This creates a jet of solution that comes from the orifice that is drawn down by acceleration to a grounded collection device located on the other side of the web. In the electrospinning device, the jets or slot are located on the side of the moving paper web opposite the grounded collection device. Typically, there is contact and some friction between the paper web and the electrode thereby inducing a charge on the web as the web advances past the stationary electrode. The discharging component of the electrospinning device can include a plurality of nozzles or the discharging component can be in the shape of a slot. Typical cross sectional areas for electrospinning nozzles can range from about 0.1 mm² to about 10 mm and can be of any usable shape although the nozzles are typically round. Discharging components having a slot shape typically have a width of between about 10-1000 microns. Typically, the diameter of the fibers produced by electrospinning are at least one order of a magnitude smaller and have larger surface area to volume ratios than fibers made by conventional extrusion techniques. Electrospinning is described in more detail in U.S. Pat. Nos. 2,158,416; 2,323,025; 6,641,773 and U.S. Pat. App. Pub. No. 2004/0223040, the disclosures of which are hereby incorporated by reference.

Nanofibers useful in accordance with the present invention typically have an average diameter of less than about 1000 micron. In accordance with certain embodiments, the average diameter of the fibers is from about 50 to about 700 microns, more particularly from about 60 to about 500 microns, and, in particular aspects of the invention, from about 200 to about 300 microns. One skilled in the art will appreciate that the fiber average diameter accounts for variations along the length of the fiber and the fact that the cross sectional shape of the fibers may have various forms such as circular, elliptical, flat or stellato.

The nanoweb layer may be applied at a coating weight of from about 0.05 to about 20 gsm (0.01 lb/1000 ft² to about 4 lb/1000 ft²), more particularly from about 0.2 to about 5 gsm (0.04 lb/1000 ft² to about 1 lb/1000 ft²) and, in accordance with particular embodiments of the invention, from about 0.5 to about 2 gsm (0.1 lb/1000 ft² to about 0.4 lb/1000 ft²) based on dry weight. Accordingly, in accordance with certain embodiments, the coat weight of the nanoweb may be about 10 times less than conventional coating materials.

Various materials can be used in forming nanofibers in the nanoweb in accordance with the present invention. Materials such as biopolymers (collagen, fibrinogen), natural polymers (alginate, cellulose derivatives, etc.), chitosan, bicompatible polymers, polycaprolactone, polyethylene oxide and the like may be used. Furthermore, the following materials may also be used: aluminum oxide, ferrofluid composite, silica, aluminosilicate, organosilicas, TiO₂ (anatase and rutile), TiN, Nb₂O₅, Ta₂O₅, TiN oxide—fluorinated and non-fluorinated, indium, tin oxide, V₂O₅, mixed oxides (Mn, Ga, Mo, W, Zn), PEO/Laponite™. Laponite™ is a commercially-available synthetic hectorite.

Polymer materials that can be used in the polymeric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly (vinylchloride), polymethylmethacrylate (and other acrylic resins), polystyrene, and copolymers thereof (including ABA type block copolymers), poly (vinylidene fluoride), poly (vinylidene chloride), polyvinylalcohol in various degrees of hydrolysis (87% to 99.5%) in crosslinked and non-crosslinked forms.

Block copolymers are also useful in accordance with certain embodiments of the invention. With such copolymers the choice of solvent swelling agent is important. The selected solvent is such that both blocks were soluble in the solvent. One example is an ABA (styrene-EP-styrene) or AB (styrene-EP) polymer in methylene chloride solvent. If one component is not soluble in the solvent, it will form a gel. Examples of such block copolymers are Kraton® type of AB and ABA block copolymers including styrene/butadiene and styrene/hydrogenated butadiene (ethylene propylene), Pebax® type of epsilon-caprolactam/ethylene oxide, Sympatex® polyester/ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly (acrylonitrile) and its copolymers with acrylic acid and methacrylates, polystyrene, poly (vinyl chloride) and its various copolymers, poly (methyl methacrylate) and its various copolymers, can be solution spun with relative ease because they are soluble at low pressures and temperatures.

Polymers useful in forming the fibers of the nanoweb typically have a melt index of between about 0.5 to about 250 g/10 min, more particularly between about 50 and about 150 g/10 min and in accordance with certain embodiments between about 50 and about 100 g/10 min. Melt Index can be determined in accordance with ASTM D1238.

The base sheet is typically formed from fibers conventionally used for such purpose and, in accordance with the particular embodiments, includes unbleached kraft pulp. The pulp may consist of hardwood or softwoods or a combination thereof. Brightness of the base sheet typically is between about 14 and 22% for unbleached fibers and between about 70 and 85% for bleached fibers before application of the nanofibers. The basis weight of the cellulose fiber layer may range from about 10 to about 700 gsm, and more particularly, from about 100 to about 600 gsm. The base sheet may also contain organic and inorganic fillers, sizing agents, retention agents, and other axillary agents as is known in the art. The final paper of the invention can contain one or more cellulose-fiber layers, nanoweb layers and, in accordance with certain embodiments, binder layers.

The present invention is described in more detailed by reference to the following non-limiting examples.

### EXAMPLE 1

A polymer solution can be prepared according to the following formulation:

| | % by weight wet |
|---|---|
| Polyvinyl Alcohol (PVOH) | 10% |
| Surfactant - Triton X400 | 0.5% |
| Plastic Pigment - Omnova 2203 | 10% |
| MF cross-linker - Cymel 385 | 10% |
| H₂O | balance |

The nanofiber formulation can be applied with an electrospinning device at a voltage of about 80 kV and electric current of about 50-400 microampere. The nanofibers are ejected from an orifice having a diameter of about 2 mm. The resulting nanofibers have an average diameter of about 200 microns. The nanofibers are applied to an unbleached board substrate having a basis weight of about 300 gsm. The nanofibers are applied at a coat weight of about 5 gsm. In accordance with this example, the nanofibers are applied in the drying section of the paper machine at a dryness level of the base stock prior to coating of about 60% (i.e., 40% wet). The composite paper can have a Parker Print smoothness of about 1.5 microns and a brightness of about 90%.

### EXAMPLE 2

A composite sheet can be prepared as in Example 1 and further provided with a binder to improve adhesion of the nanofibers to the base stock. A binder composition comprising about a 5% aqueous solution of polyvinyl alcohol can be applied to the base stock before the nanofibers. In this example, the binder is applied at a dry coat weight of about 1 gsm. The binder may be applied at a dryness level of about 55% by weight and then the nanofibers are applied at a dryness level of about 60%.

The finished sheet of Example 2 exhibits improved adhesion compared to a sheet prepared in accordance with Example 1. Adhesion can be measured in accordance with an IGT Reprotest using an AIC2-5 printability tester. The test can be conducted according to PAPRO Method 2.403 and ISO 3782, 3783. Results are provided in the following table.

TABLE 1

| Sample | IGT |
|---|---|
| Example 1 | 70 |
| Example 2 | 100 |

Having described the invention in detail, it will be apparent that modifications and variations are possible without departing from the scope of the invention defined in the appended claims.

What is claimed is:

1. A method of forming a paper or paperboard comprising the steps of:
forming a web of cellulose paper fibers,
producing a plurality of nanofibers and
applying the nanofibers to the web of paper fibers at a dryness level of the paper fiber web of about 40% to about 100% by weight to produce a composite paper web comprising a nanoweb layer comprising nanofibers and the web of cellulose paper fibers.

2. The method of claim 1 wherein the coat weight of the cellulose fiber web is from about 10 to about 700 gsm.

3. The method of claim 1 further comprising providing a binder between the nanoweb and the cellulose web.

4. The method of claim 3 wherein the binder is applied to the cellulose web before the nanofibers are applied to the cellulose web.

5. The method of claim 3 wherein the binder has a glass transition temperature of between about 10° C. and about 100° C.

6. The method of claim 5 wherein the binder has a glass transition temperature of between about 20° C. and about 50° C.

7. The method of claim 3 wherein the binder is applied at a coat weight of between about 0.05 and about 15 gsm based on dry weight.

8. The method of claim 1 wherein the nanofibers are applied to the web of paper fibers at a dryness level of the paper fiber web of about 50% to about 80% by weight.

9. The method of claim 3 wherein said binder is selected from the group consisting of polyvinyl alcohol, polyvinyl pyrrolidone and combinations thereof.

10. The method of claim 1 wherein said nanofibers are produced using an electrospinning device.

11. The method of claim 10 wherein said electrospinning device comprises a plurality of nozzles, each nozzle having a cross-sectional area of from about 0.1 mm² to about 10 mm².

12. The method of claim 10 wherein said nanoweb comprises nanofibers selected from the group consisting of polymeric, metaloxide and composites thereof.

13. The method of claim 1 wherein said nanofibers have an average diameter in the range from about 50 nm to about 700 nm.

14. The method of claim 1 wherein said nanoweb is applied at a coat weight of from about 0.2 to about 5 gsm.

15. The method of claim 1 further comprising:
calendering the web of cellulose paper fibers to a Parker Print smoothness of between about 2 and about 6 prior to application of the nanoweb.

16. The method of claim 1 wherein the nanofibers are applied to the web of paper fibers in a drying section of a paper machine.

17. The method of claim 16 wherein the nanofibers are produced using an electrospinning device.

18. The method of claim 17 wherein the drying section comprises from about 5 to about 15 drying cylinders positioned before the electrospinning device and from about 10 to about 100 drying cylinders after the electrospinning device.

19. A paper or paperboard produced in accordance with claim 1.

20. A paper or paperboard produced in accordance with claim 15.

21. A method for forming a composite paper comprising cellulose fibers and nanofibers comprising:
forming a cellulosic slurry comprising cellulose fibers and water,
depositing said cellulosic slurry onto a wire of a papermaking machine to form a base paper web;
inducing a charge on the base paper web at a dryness level of about 40% to about 100% by weight; and
discharging a polymer solution from a discharging component by subjecting the polymer solution to an electric field wherein the electric field creates a jet of polymer solution, the jet of polymer solution accelerating toward the charged base paper web as nanofibers, thereby forming a composite paper web comprising nanofibers and cellulose fibers.
